(19) United States
(12) Patent Application Publication
(10) Pub. No.: US 2010/0223037 A1
(43) Pub. Date: Sep. 2, 2010

(54) BIOLOGICAL MODELS

(75) Inventors: Jérôme Feret, Paris 5e (FR); Vincent Danos, Edinburgh (GB); Jean Krivine, Paris (FR); Russell Harmer, Montreuil (FR); Walter Fontana, Brighton, MA (US)

Correspondence Address: PROSKAUER ROSE LLP, ONE INTERNATIONAL PLACE, BOSTON, MA, 02110, US

(73) Assignee: Plectix Biosystems, Inc., Cambridge, MA (US)

(21) Appl. No.: 12/572,127

(22) Filed: Oct. 1, 2009

Related U.S. Application Data
(60) Provisional application No. 61/101,970, filed on Oct. 1, 2008.

(51) Int. Cl. G06G 7/58; G06F 17/10; G06N 5/02

(52) U.S. Cl. 703/2; 703/11; 706/47

(57) ABSTRACT

Described are computer-based methods and apparatuses, including computer program products, for biological models. Data indicative of a molecular system is received, the data comprising a rule-based model of the molecular interactions. A set of one or more internal variables of the data is calculated based on one or more syntactical rules, wherein the set of one or more internal variables comprises one or more fragments. The representation is generated based on the set of one or more internal variables, wherein the representation comprises one or more coupled ordinary differential equations.

### CROSS REFERENCES TO RELATED APPLICATIONS

This application claims the benefit of and priority to U.S. Provisional Application No. 61/101,970, filed on Oct. 1, 2008, and titled “Biological Models,” the disclosure of which is hereby incorporated herein by reference in its entirety.

### FIELD OF THE INVENTION

The present invention relates generally to computer-based methods and apparatuses, including computer program products, for biological models, and more particularly to automated techniques of generating models of molecular signaling networks.

### BACKGROUND

Molecular biology can disassemble cellular systems and anchor cell-biological behaviors of staggering complexity in chemistry. This raises the challenge of reconstituting molecular systems formally to, for example, make their behavior more intelligible and their control more deliberate. It is beneficial to reconstruct molecular systems to not only help cure disease, but also to understand the complexity of cellular phenotypes.

The traditional ways of modeling biological systems can be impractical because biological systems are too large to deal with. In the context of cellular signaling, for example, the posttranslational modification of proteins and their noncovalent association into transient complexes generates an astronomical number of possible molecular species that can relay signals. Therefore, such modeling methods leave unanswered the question of how to reason about system dynamics if one cannot possibly consider a relation (e.g., a differential equation) for each chemical species that can appear in a system.

A rule-based approach can solve the problem, but at the same time the simulation of the systems of the rule-based model is potentially slow and expensive to simulate. It is therefore desirable to have a fast simulation technique to translate the rule-based models back into differential equations. The result is an abstraction of the description that is more like traditional tasks. The rule-based approach can be brought within reach of traditional techniques, because they can be applied to differential equations extracted from the rule-based models. The result is a fast and cost effective simulation.

Most models contain parameters, and the model can be calibrated so the model fits empirical observations. For doing this, many different parameter combinations can be tested, where the system runs to see how it behaves. To run such a system stochastically, it would take a long time. By generating abstracted differential equation versions, the parameter estimation techniques become applicable to the rule-based cases. This enables not only fast simulation of the rule-based models, but also calibration of rule-based models. Calibration is important because the model is intended to represent how the actual system performs.

With a large system of molecules that interact, because of the various ways they can interact there are many states the molecules can have (e.g., each an be tagged at a variety of sides). The potential combinations are huge. Traditional systems would need one equation for each state. Thus, for a simple two molecule system there could be potentially millions of equations. A rule-based model instead can represent the system in terms of tapping into the molecules. This coarse-grained simulation can describe a method of projecting the rule-based system back onto the previous system. It can result in a smaller system that contain the units that are dynamically consequential.

Yet, to explore the dynamics of a system of rules, such rule-based approaches must resort to computationally expensive stochastic simulations. Ordinary differential equations (ODEs) could be highly useful for rapidly exploring system dynamics by numerical integration, but a flat-out expansion of rules into ODEs would fall victim to the combinatorial explosion.

### SUMMARY OF THE INVENTION

The techniques described herein provide methods, apparatuses, and computer program products for biological modeling. Such modeling facilitates the construction of a self-consistent dynamical system of coarse-grained variables, determined by what the system dynamics itself can distinguish (and not by what an external observer may chose to measure).

In one aspect, there is a method. The method is a computerized method for automatically generating a representation of a molecular system. The method includes receiving, by an input unit of a computer, data indicative of a molecular system, the data including a rule-based model of the molecular interactions. The method also includes calculating, by a preprocessing unit of the computer, a set of one or more internal variables of the data based on one or more syntactical rules, wherein the set of one or more internal variables includes one or more fragments. The method also includes generating, by a model generation unit of the computer, the representation based on the set of one or more internal variables, wherein the representation includes one or more coupled ordinary differential equations.

In another aspect, there is a system. The system is for automatically generating a representation of a molecular system. The system includes an input unit of a computer configured to receive data indicative of a molecular system, the data including a rule-based model of the molecular interactions. The system also includes a preprocessing unit of the computer in communication with the input unit, configured to calculate a set of one or more internal variables of the data based on one or more syntactical rules, wherein the set of one or more internal variables includes one or more fragments. The system also includes a model generation unit of the computer in communication with the preprocessing unit, configured to generate the representation based on the set of one or more internal variables, wherein the representation includes one or more coupled ordinary differential equations.

In another aspect, there is a computer program product. The computer program product is tangibly embodied in a computer readable medium. The computer program product includes instructions being operable to cause a data processing apparatus to receive data indicative of a molecular system, the data including a rule-based model of the molecular interactions. The instructions are also operable to cause a data processing apparatus to calculate a set of one or more internal variables of the data based on one or more syntactical rules, wherein the set of one or more internal variables includes one or more fragments. The instructions are also operable to cause a data processing apparatus to generate the representation based on the set of one or more internal variables, wherein the representation includes one or more coupled ordinary differential equations.

In another aspect, there is a system. The system is for automatically generating a representation of a molecular system. The system includes means for receiving, by an input unit of a computer, data indicative of a molecular system, the data including a rule-based model of the molecular interactions. The system also includes means for calculating, by a preprocessing unit of the computer, a set of one or more internal variables of the data based on one or more syntactical rules, wherein the set of one or more internal variables includes one or more fragments. The system also includes means for generating, by a model generation unit of the computer, the representation based on the set of one or more internal variables, wherein the representation includes one or more coupled ordinary differential equations.

In other examples, any of the aspects above can include one or more of the following features. The one or more fragments can include a plurality of molecular entities whose dynamical roles are indistinguishable at the level of the rule-based model. The representation of the molecular entities can include one or more agents and one or more sites.

In some examples, the one or more syntactical rules are generated based on one or more properties, the one or more properties including verifying no fragment property overlaps a left-hand component of a rule on a modified site, verifying the one or more fragments partitions each component of the rule-based model so that each component can be expressed as a sum of orthogonal fragments, or both. Generating can include generating the representation such that the representation is self-consistent, wherein the dynamics of each fragment of the one or more fragments is a function of the remaining fragments of the one or more fragments, and a first state of the representation is equal to a second state of the representation, wherein the first state is calculated by numerically integrating the one or more fragments, and the second state is calculated by numerically integrating the rule-based system and then generating the one or more fragments.

In other examples, a set of one or more parameters of the rule-based model is calibrated, including fitting a set of one or more parameters of the generated representation of the rule-based model. A complexity metric of the rule-based model can be defined based on the one or more fragments and one or more relationships between the one or more fragments. A second complexity metric of a second rule-based model can be defined based on one or more fragments of the second rule-based model and one or more relationships between the one or more fragments of the second rule-based model, and whether the rule-based model is equivalent to the second rule-based model based on the first complexity metric and the second complexity metric can be determined. The complexity metric can include counting and characterizing the size of one or more fragments that make up the representation generated from the rule-based model.

In some examples, a plurality of different potential drug targets is calculated, wherein each drug target is a molecular entity within a same fragment from the one or more fragments, each drug target of the plurality of different potential drug targets having the same dynamical consequences as the other drug targets. Calculating the set of one or more internal variables can include generating a contact map, the contact map representative of a plurality of agents and a plurality of bonds between the agents, and generating an annotated contact map based on the contact map, the annotated contact map being generated based on one or more criteria that determine valid coverings for each agent of the plurality of agents and a type of bond of each agent. The one or more fragments can be assembled such that each agent within the fragment has a set of one or more sites that is a class, and each site of the one or more sites has a binding site selected from the group consisting of free, bound, or stubbed.

The techniques, which include both methods and apparatuses, described herein can provide one or more of the following advantages. A dynamical system of coarse-grained variables (i.e., fragments) can be automatically generated from a given set of rules (e.g., rules of a rule-based model). The systems and methods are exact in that coarse-graining (e.g., generating the fragments) first and then integrating the fragment ODEs is equivalent to first integrating network ODEs at the level of molecular species and then coarse-graining. Additionally, because the fragments are constructed directly from the rules, the fact that the ground system is oftentimes ineffable due to combinatorial blow-up is of no consequence. The systems and methods exploit the fact that when using a rule-based model, some molecular species may not always be meaningful units of the dynamics, and can therefore be lumped together into a fragment. The systems and methods can utilize properties (e.g., “no overlap”, where no fragment properly overlaps a lhs component of a rule on a modified site, and “orthogonality”, where fragments must partition anything that is contained within the fragment) to ensure a self-consistent coarse-grained system whose dynamics is sound. Therefore, the set of molecular species can be refined to a trivial set of fragments that are generated based on the properties of the system.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 illustrates an exemplary biological modeling system according to the present invention;

FIGS. 2A and 2B illustrate an exemplary diagram of a rule-based molecular interaction according to the present invention;

FIG. 3 illustrates an exemplary process for verifying that a set of fragments for the biological model satisfies one or more predetermined properties, according to the present invention;

FIG. 4 illustrates an exemplary diagram for defining fragments according to the present invention;

FIG. 5 illustrates an exemplary process for generating a molecular model according to the present invention;

FIGS. 6A-6B illustrate rules for a rule-based model of a small section of early events in epidermal growth factor;

FIG. 7A illustrates an exemplary contact map according to the present invention;

FIG. 7B illustrates an exemplary annotated contact map according to the present invention;

FIG. 8 illustrates an exemplary method for annotating a contact map according to the present invention;

FIGS. 9A-9E illustrate exemplary diagrams of the syntactical criteria according to the present invention;

FIGS. 10A-10B illustrate exemplary fragments that are generated according to the present invention; and

FIGS. 11A-11B illustrate an exemplary list of compressed rules from which the thirty-eight fragments of FIGS. 10A-10B were derived according to the present invention.

### DETAILED DESCRIPTION

The systems and methods described herein can be applied to any chemical system. For example, the system can not only be applied to a biological disease, but also to the general intervention in controlling a chemical system. A drug, for example, tries to control a chemical system. The systems and methods disclosed herein can be used to facilitate the identification of causally relevant molecular patterns in a chemical reaction system.

In general overview, a rule-based model is converted into a reduced system of rate equations by identifying molecular patterns (e.g., sets of species) that act independently. Internal coarse graining of the rule-based model is performed to generate fragments, which seeks as variables those molecular patterns that establish the finest level of resolution at which the dynamics of the system is capable of making distinctions, thus rendering finer-grained patterns unwarranted. For example, all the various molecular states that might occur in a cell may not be of significance, but which ones have a potential biological significance can be determined via the rule-based method. Knowing which molecular states are potentially of significance can be more effective in identifying targets for drug intervention by actually homing into the things that are relevant. New views can be generated that may enable a pharmaceutical company to identify new targets for intervention.

For example, the various interactions in a system can cause Object A to bind to Object B and then Object B binds to Object C. Another interaction might cause Object A to bind to Object B which binds to Object D, which in turn binds to Object C. It might be that the dynamics of the system cannot distinguish how Object A is bound to Object C (whether it is through B alone or through B and D). If a system lacks interactions by which such distinctions can be made, the system cannot exploit the distinctions, so the distinctions are therefore not relevant in describing the system's dynamics. The system can be isolated to see the distinctions that a system is capable of making (e.g., which may differ from the distinctions an observer external to the system is capable of making) Such distinctions can be extracted, which the system is capable of making through fragments. The description can be in terms of patterns of molecules and dynamics of those molecules (e.g., rather than in terms of molecules). These can be distinguishable based on the interactions laid down in the rules that define the models. The system can identify the causally relevant patterns based on the interactions.

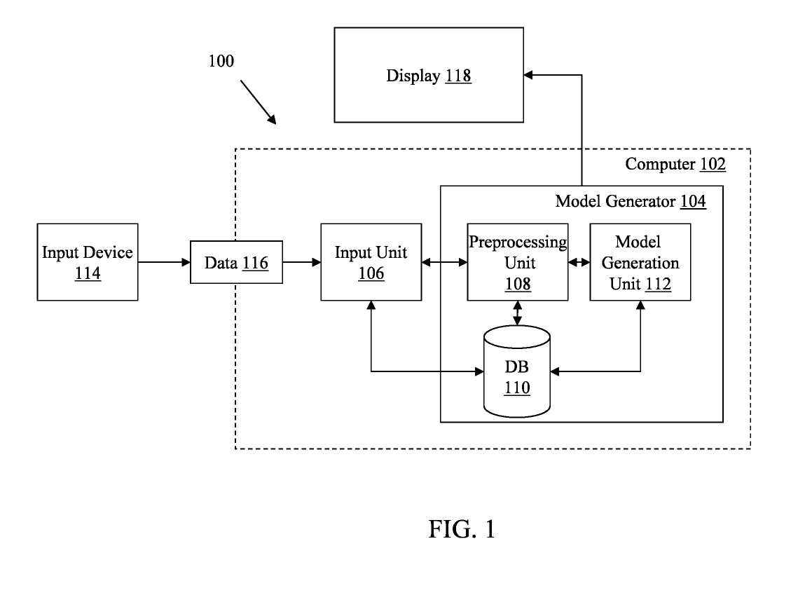

FIG. 1 illustrates an exemplary biological modeling system 100 according to the present invention. The biological modeling system 100 includes computer 102. Computer 102 includes model generator 104 and input unit 106. Input unit 106 is in communication with preprocessing unit 108 and the database 110 (e.g., a data storage device). The preprocessing unit 108 is in communication with the database 110 and the model generation unit 112, and the model generation unit 112 is in communication with the database 110. Input device 114 is in communication with the input unit 106, and transmits data 116 to the input unit 106. Computer 102 is in communication with display 118.

The computer 102 is a computing system (e.g., a programmable, processor-based system) specially configured to generate biological models. The computer 102 may include, for example, a microprocessor, a hard drive (e.g., database 110), random access memory (RAM), read only memory (ROM), input/output (I/O) circuitry, and any other necessary computer components. The computer 102 is preferably adapted for use with various types of storage devices (persistent and removable), such as, for example, a portable drive, magnetic storage (e.g., a floppy disk), solid state storage (e.g., a flash memory card), optical storage (e.g., a compact disc or CD), and/or network/Internet storage. The computer 102 may comprise one or more computers, including, for example, a personal computer (e.g., an IBM-PC compatible computer) or a workstation (e.g., a SUN or Silicon Graphics workstation) operating under a Windows, MS-DOS, UNIX, or other suitable operating system and preferably includes a graphical user interface (GUI).

The input unit 106 enables information to be communicated to the model generator 104. For example, the input unit 106 provides an interface for a user to communicate with the biological modeling system 100 via input device 114. The terms user and operator both refer to a person using the biological modeling system 100 and are sometimes used interchangeably. The input device 114 may include any device enabling a user to provide input to a computer. For example, the input device 114 can include a known input device, such as a keyboard, a mouse, a trackball, a touch screen, a touch pad, voice recognition hardware, dials, switches, buttons, a foot pedal, a remote control device, a scanner, a camera, a microphone, and/or a joystick.

The input device 114 is in operative communication with the computer 102. For example, the input device 114 may be coupled to the computer 102 via an interface (not shown). The interface can include a physical interface and/or a software interface. The physical interface may be any known interface such as, for example, a wired interface (e.g., serial, USB, Ethernet, CAN bus, and/or other cable communication interface) and/or a wireless interface (e.g., wireless Ethernet, wireless serial, infrared, and/or other wireless communication system). The software interface may be resident on the computer 102 (e.g., in the input unit 106).

The display 118 is a visual interface between the computer 102 and the user. The display 118 is connected to the computer 102 and may be any device suitable for displaying text, images, graphics, and/or other visual output. For example, the display 118 may include a standard display screen (e.g., LCD, CRT, plasma, etc.), a touch screen, a wearable display (e.g., eyewear such as glasses or goggles), a projection display, a head-mounted display, a holographic display, and/or any other visual output device. The display 118 may be disposed on or near the computer 102 (e.g., mounted within a cabinet also comprising the computer 102) or may be remote from the computer 102 (e.g., mounted on a wall or other location suitable for viewing by the user). The display 108 may be used to display any information useful for a modeling procedure, such as, for example, graphical models (e.g., models that include agents, sites, bonds, internal states, etc.).

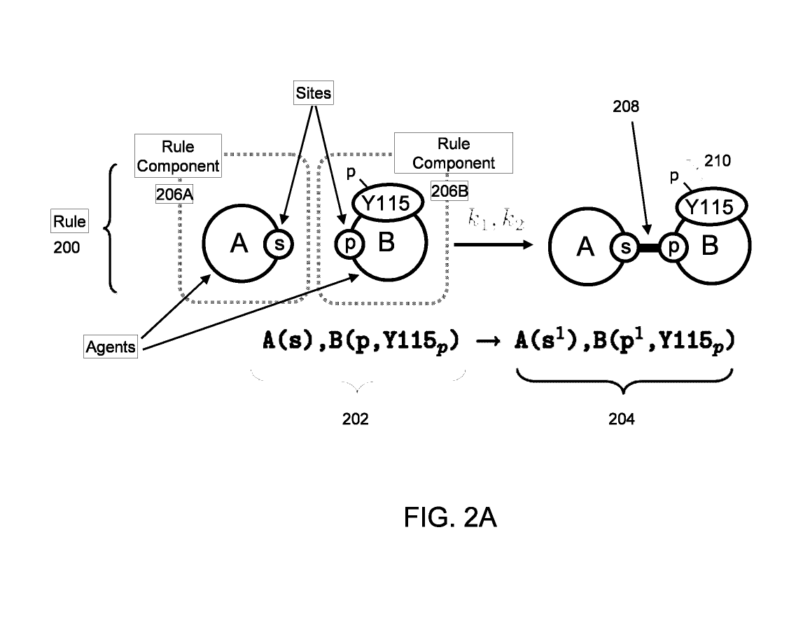

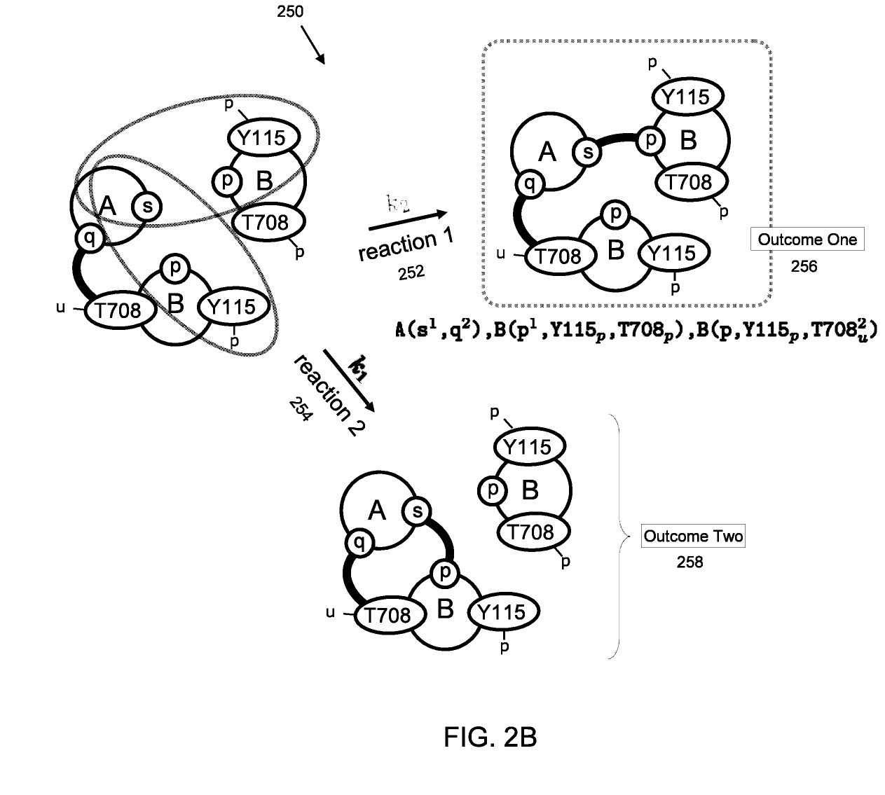

A language can be used to define molecular biology to cast rules of interaction. For example, the formal language Kappa can be used to define agents (e.g., to represent proteins) as sets of sites that constitute abstract resources for interaction. FIGS. 2A and 2B illustrate an exemplary diagram of a rule-based molecular interaction. FIG. 2A illustrates an exemplary rule 200. Rule 200 has a left-hand side (lhs) 202 and a right-hand side (rhs) 204. Lhs 202 includes rule component 206A and rule component 206B. Rule 200 includes rate constant k₁ and k₂. Sites (e.g., “s”, “p”, and “Y115”) can hold an internal state, as generated through posttranslational modifications, and engage in binding relations with sites of other agents (or proteins). The nodes of FIG. 2 are agents (e.g., “A” and “B”), but the endpoints of edges are sites (e.g., the edge 208 ends at sites “s” and “p”, which belong to agents “A” and “B”, respectively). Although an agent can bear many connections (e.g., agent “B” can bear connections through sites “p” and “Y115”), a site can bear only one connection (e.g., the connection 208 from site “s” to “p”).

A rule (e.g., rule 200) captures a high-level mechanistic statement (empirical or hypothetical) about a protein-protein interaction in terms of a rewrite directive plus rate constant(s). The lhs (e.g., lhs 202) of the rule is a pattern of partially specified agents and represents the contextual information necessary for identifying reaction instances that proceed according to the rule. The rhs (e.g., rhs 204) expresses the actions that may occur when the conditions specified on the lhs are met in a reaction mixture of Kappa agents. A maximal connected subgraph on the lhs of a rule is called a rule component (e.g., rule component 206A and rule component 206B). Rule 200 can be conveyed as either a two or three dimensional model (e.g., the circles and spheres in FIG. 2A), as well as textually (e.g., A(s), B(p, Y115ₚ)→A(s¹), B(p¹, Y115ₚ)). In textual representations, agents are names (e.g., “A”) followed by an interface of sites delimited by parentheses. Bonds are labeled by superscripts (e.g., “1”) and internal states at a site by subscripts (e.g., “p”). In the graphical rendition, internal states are indicated as labeled barbs (e.g., barb 210).

FIG. 2B is a diagram 250 of the combination of rule component 206A and rule component 206B. Diagram 250 includes reaction one 252 and reaction two 254, which result in outcome one 256 and outcome two 258, respectively. An association of proteins (or agents) is a connected (site) graph, called a complex (of agents), as shown in the box of outcome one 256. The rule in FIG. 2A matches a combination of agents (e.g., agents A and B) in two distinct ways giving rise to two possible reactions, reaction one 252 and reaction two 254 with different outcomes. Note that because of their local nature, Kappa rules with one lhs component may apply in both a unimolecular (i.e., outcome one 256) and bimolecular situation (i.e., outcome two 258). This is why such rules are given two rate constants, a first-order (k₁)and a second-order (k₂) constant. A textual representation of the reaction in FIG. 2B is A(s¹,q²), B(p¹,Y115ₚ), B(p,Y115ₚ,T708²ᵤ).

Kappa can be used to express tunable rules of interaction between proteins characterized by discrete modification and binding states. The idea of a rule, rule 200, is to stipulate only the molecular context required for an interaction along with some rate constant(s). The lhs (lhs 202) of a rule is any site graph. Agents may mention a subset of their sites and omit states. The rhs (rhs 204) exhibits the changes that occur when the lhs is matched in a mixture of agents. The difference between rhs and lhs is called the “action of the rule.” Sites mentioned on the lhs are said to be “tested” by the rule. Sites that are tested but not modified constitute the context of a rule's action. Because rules typically do not mention all of the sites and states of an agent, they keep combinatorial complexity implicit, obviating the need for eliminating it. A molecular species (also referred to as a ground-level object) is a complex in which each agent occurs with a complete set of sites in definite states. The complete set of sites defines the finest grain of resolution at which the state of an agent is known. Like rules, this set of sites can be updated to reflect new knowledge or hypotheses. Rules can give rise to potentially numerous reaction instances (whose rate constants are related to the rate constant(s) of the rule, k₁ and k₂ in FIG. 2A). These instances involve particular combinations of molecular species, each of which satisfies the context required for the rule to apply (e.g., to generate outcome one 256 and outcome two 258 of FIG. 2B). Kappa rules can be, for example, both descriptions of mechanistic knowledge and executable instructions. For example, Kappa can be implemented as a programming language attuned to molecular signaling. A Kappa model of a biological system is a concurrent computer program system whose instructions are rules that asynchronously change the state of a shared store representing the reaction mixture on which the rules act. Computer programs can generate formal objects that can be analyzed statically.

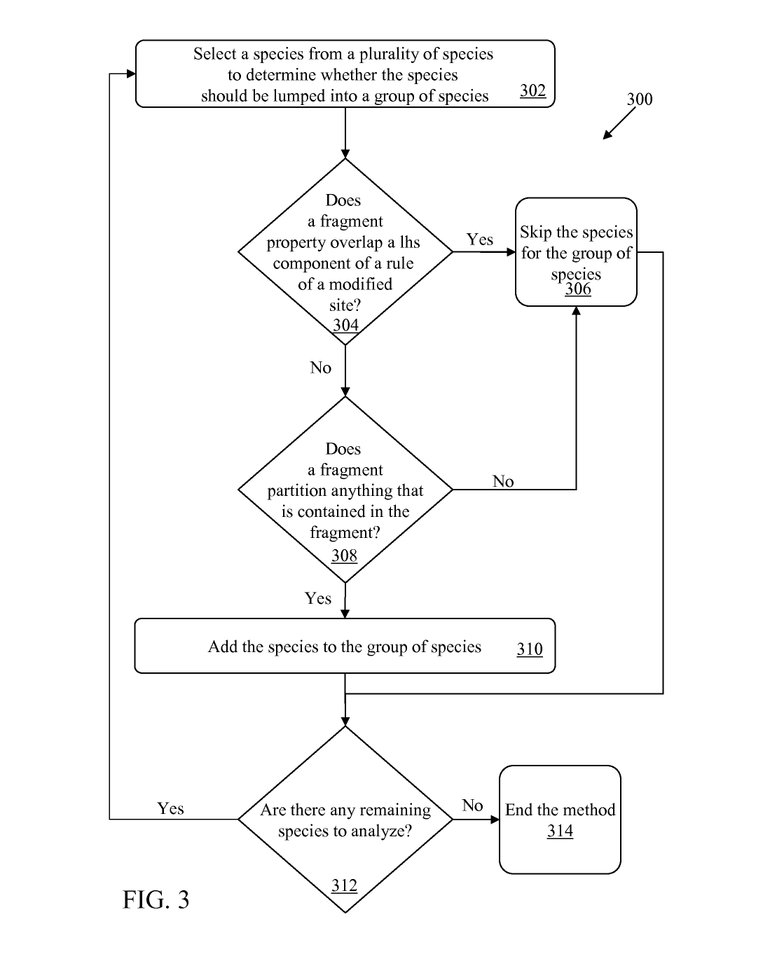

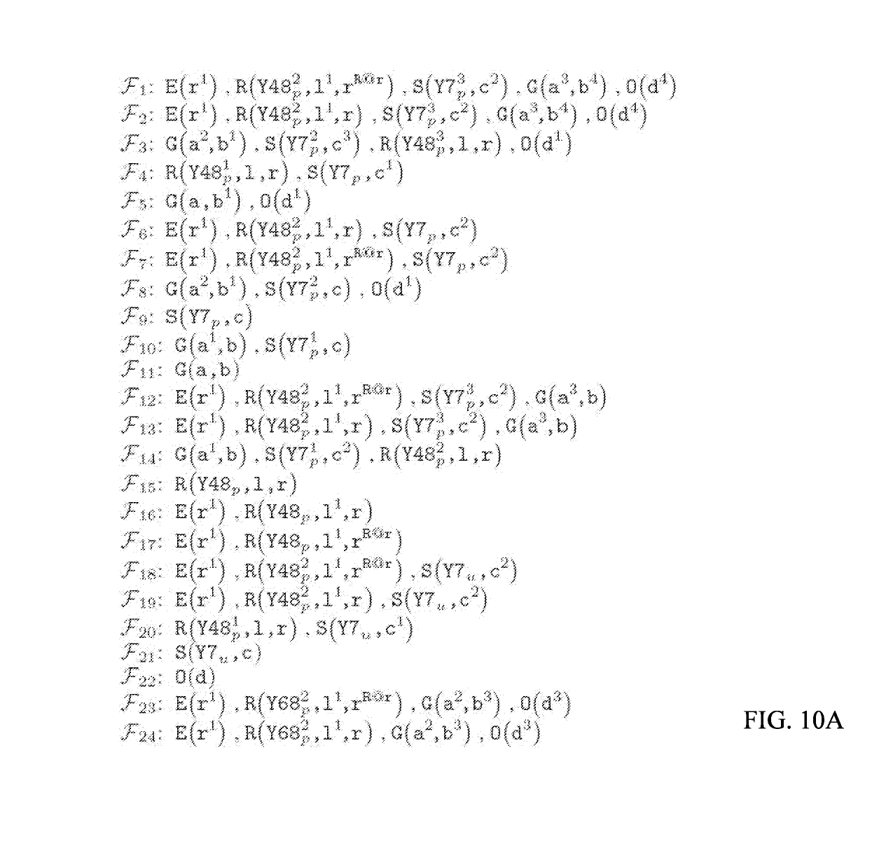

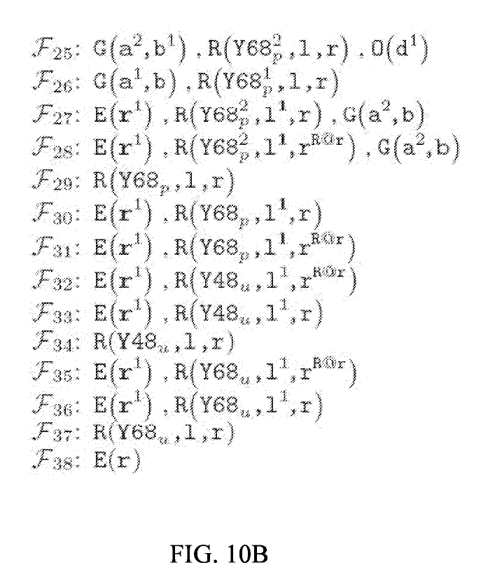

FIG. 3 is an exemplary flow chart illustrating a process 300 for ensuring (or verifying) that a suitable set of coarse-grained dynamical units for the representation, referred to as “fragments,” (see, e.g., FIGS. 10A-10B) satisfies one or more predetermined properties. Dynamical, or dynamically equivalent, mean that perturbing the concentration, for example, of one entity in a set S has the same effect at the level of sets as perturbing another entity in the same set S. At step 302, the system (e.g., the biological modeling system 100 of FIG. 1) selects a species from a plurality of species to determine whether the species should be lumped into a group of species. At step 304, the system determines whether a fragment properly overlaps a lhs component of a rule on a modified site (e.g., the “no overlap” property). If a fragment property does overlap a lhs component, at step 306 the system skips the selected species for the group of species. If there are no fragment properties that overlap a lhs component, at step 308 the system determines whether a fragment partitions anything that is contained in the fragment (e.g., the “orthogonality” property). If the fragment does not, the process 300 proceeds to step 306 as discussed above. If the fragment does, at step 310 the system adds the species to the group of species. At step 312, the system determines whether there are any remaining species to analyze. If there are, the process 300 recursively proceeds back to step 302. Otherwise, the system proceeds to step 314 and ends (terminates) the method.

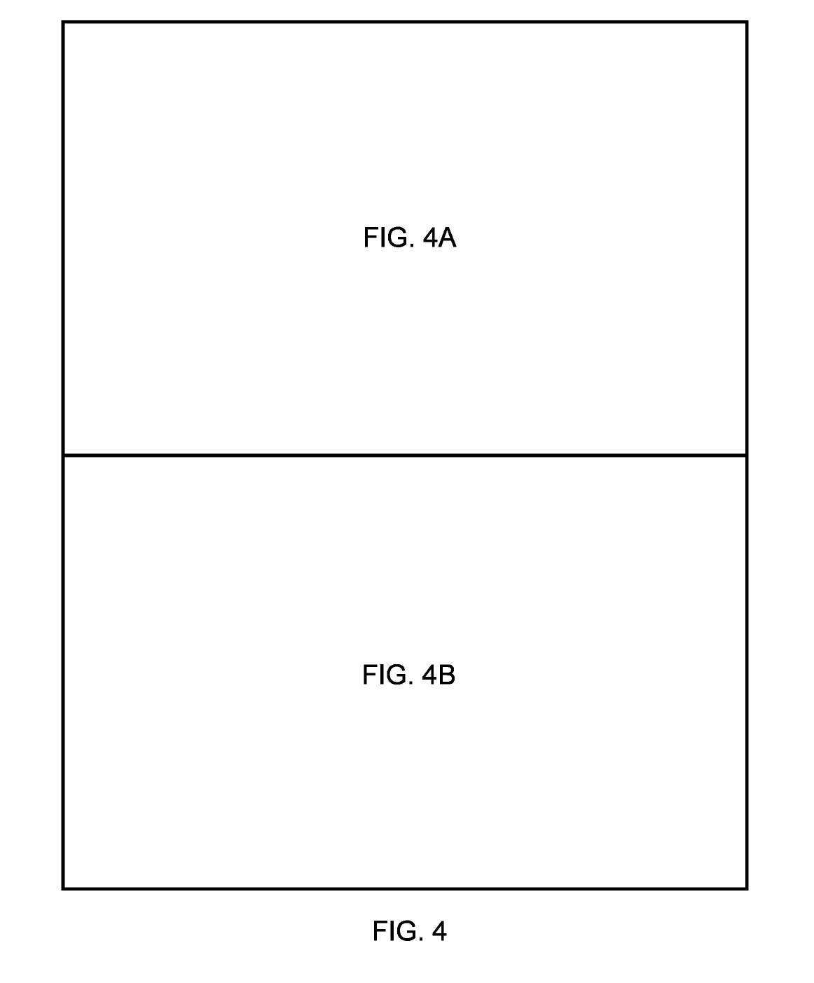

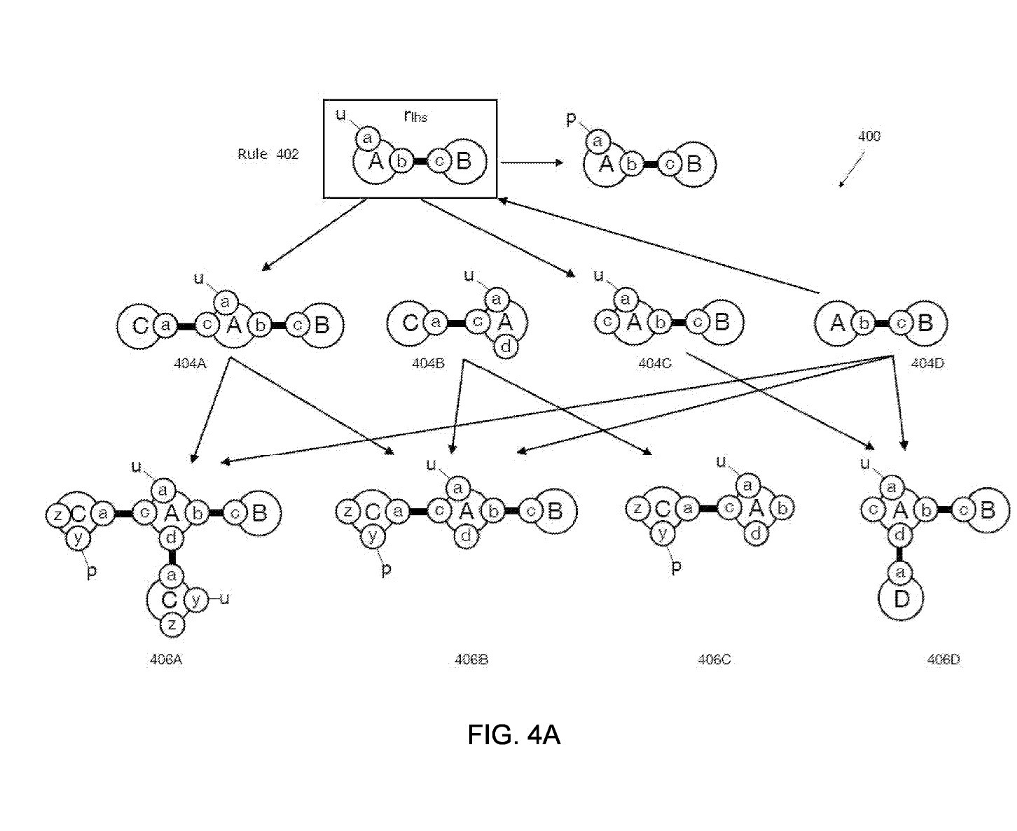

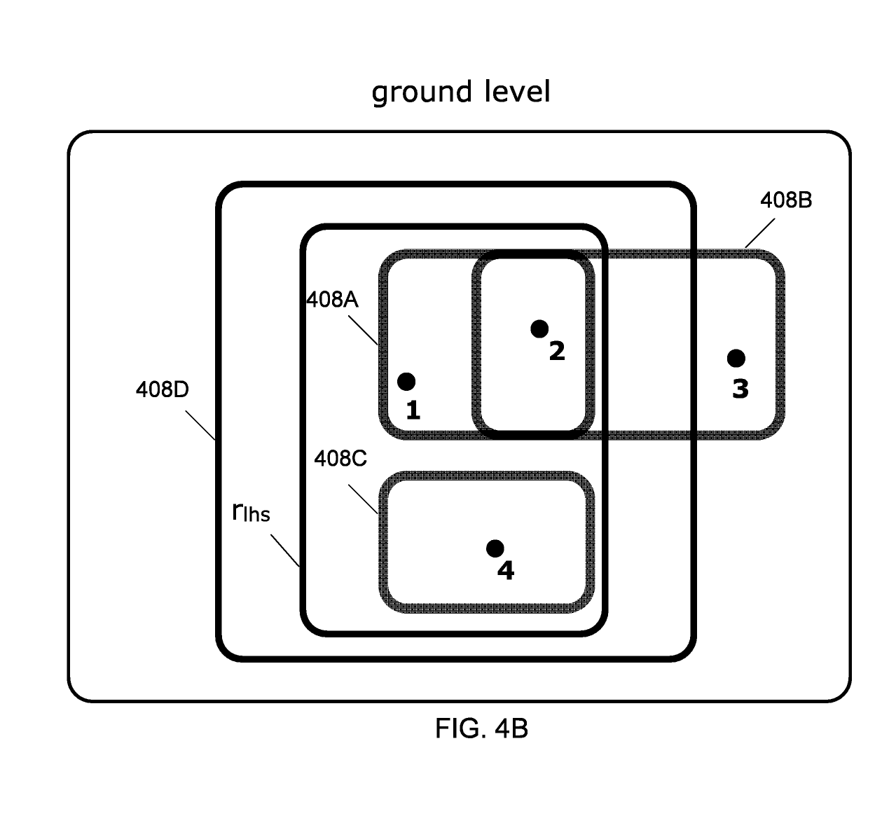

Advantageously, process 300 exploits the fact that using a rule-based model, some molecular species may not always be meaningful units of the dynamics, and are therefore lumped together into a fragment. With further respect to step 304, this step defines fragments and can help to express the rate function of a fragment in terms of fragments. FIG. 4 illustrates an exemplary diagram 400 to illustrate the concept of defining fragments. Diagram 400 includes a rule 402, a set of patterns 404 (i.e., patterns 404A, 404B, 404C, and 404D, collectively patterns 404), ground level objects 406 (i.e., ground level objects 406A, 406B, 406C, and 406D, collectively ground level objects 406), and rectangles 408 (i.e., rectangles 408A, 408B, 408C, 408D, and rectangle rₗₕₛ, collectively rectangles 408) indicative of relationships between the sets of molecular species that match the patterns 404.

Rule 402 is a (unimolecular) rule whose lhs component is rₗₕₛ. Rule 402 consumes those species that match rₗₕₛ. The ground-level objects 406 are fully specified molecular species. Arrows indicate embedding relations of one pattern into another. The rectangles 408 provide a schematic of relationships between sets of molecular species that match the patterns 404 and the rₗₕₛ (e.g., pattern 404A is depicted by rectangle 408A, and the rₗₕₛ of rule 402 is depicted by rectangle rₗₕₛ). Particularly, rectangle 408D embeds into rectangle rₗₕₛ; the matching instances of 408D are therefore a superset of the matching instances of rₗₕₛ. Also, 408D does not overlap with rₗₕₛ on a site that rule 402 modifies. Therefore, rule 402 has no effect on pattern 404D.

For example, one can think of a pattern X in terms of its extension X^{⋄}, which is the set of species that match X, accounting for the many ways in which any such species might match X (think symmetries). The extension r^{⋄}ₗₕₛ of rₗₕₛ is shown schematically in FIG. 4 as the area within rectangle rₗₕₛ, standing for the set of all molecular species implied by the rules of a system and an initial condition. FIG. 4 provides assistance for reasoning about the suitability of a few sample patterns as potential fragments in light of the property defined in step 304 of FIG. 3. For example, consider pattern 404B. Although pattern 404B does not itself match rₗₕₛ, some ground-level instances of 404B do, such as ground level object 406B. Thus, B⁵⁶⁶ (properly) intersects r^{⋄}ₗₕₛ, which makes it impossible to express the contribution of the unimolecular rule 402 to the consumption rate of 404B in terms of 404B alone. Rather, the biological modeling system 100 would have to know at any time the fraction of molecular species that occurs in the intersection of B^{⋄ with r}^{⋄}ₗₕₛ, which is a property that requires knowing the complete reaction mixture at any time. By contrast, A^{⋄} is entirely contained within rₗₕₛ. As a consequence, the firing of rule 402 will consume the pattern A at a rate proportional to its concentration [A], defined at t=0 by the number of embeddings of A in the reaction mixture. There is no need to know the reaction mixture for any subsequent time. The case of C is analogous to that of A.

It is possible to refine B into B′ by adding context, such that B′^{⋄}b⊂r^{⋄}ₗₕₛ. For example, connecting agent “A” at site “b” to agent “B” at “c” yields B′=C (a¹), A (aᵤ, c¹, d, b²), B (c²) with B′^{⋄}=B^{⋄}∩A^{⋄}. Thus, as far as rule 402 is concerned, patterns 404A, 404C, and 404B′ are fragment candidates by virtue of their extensions being inside r^{⋄}ₗₕₛ. However, other rules in the system may further constrain these potential fragments. The procedure to construct fragments can depend on all rules of a given system.

With further respect to step 308, in some embodiments fragments must partition (in the extension sense) anything that is contained within a fragment, which will be referred to as a “subfragment.” For example, any lhs component of a rule is a subfragment (the property described in step 304 of FIG. 3 clarifies this for particular components). The rate equation for a fragment affected by a rule of molecularity >1 (i.e. a rule with two or more lhs components) gets a contribution consisting of a monomial involving several fragments. Consider, for example, a rule of type Z, Z′→Z*, Z′, which modifies the lhs component Z into Z*. Consider further a particular fragment A that is a refinement of Z and is thus consumed by the rule (A^{⋄}⊂Z^{⋄}. The consumption rate of A will be proportional to [A] [Z′]. If only 1 fragment, say B, matches the lhs component Z′, then [Z′]=[B]. However, there may be several fragments Bᵢ that match Z′, in which case [Z′] should be the sum over all [Bᵢ]. The only problem is that the Bᵢ might have ground-level extensions B^{⋄}ᵢ that overlap, causing the naive sum to overcount. Thus, there must be a set of fragments that partitions Z′^{⋄}, so that [Z′] can be expressed as a sum of orthogonal fragments. The property embodied in step 308 of FIG. 3 helps to, for example, guarantee that the concentration of any subfragment can be expressed in terms of fragment concentrations.

Advantageously, the properties embodied in steps 304 and 308 of FIG. 3 can jointly ensure a self-consistent coarse-grained system whose dynamics is sound. Self-consistent refers to the property that the dynamics of each fragment of the one or more fragments is a function of the remaining fragments of the one or more fragments. Soundness means that computing the ground-level dynamics and then coarse-graining yields the same result as coarse-graining at the outset and then running the coarse-grained dynamics.

For example, if the biological modeling system 100 groups the molecular entities present in a system at time t=0 into sets as determined by the methods described herein, and then numerically integrates the evolution of these sets until time t with the equations generated as described herein, the end result is precisely the same state as if the biological modeling system 100 were to numerically integrate the reaction-based system until time t and then lump the contents of the system into sets. As can be seen from the above description with reference to FIG. 3, the (possibly infinite) set of molecular species is always a trivial set of fragments enjoying properties of the system (e.g., the properties of steps 304 and 308), but typically far from optimizing the criterion of dynamical distinguishability. Syntactical criteria can be implemented based on the properties that construct dynamical units whose boundaries are carved out by the actions available to the system directly from the rules, rather than delving into the ineffable ground-level network of species.

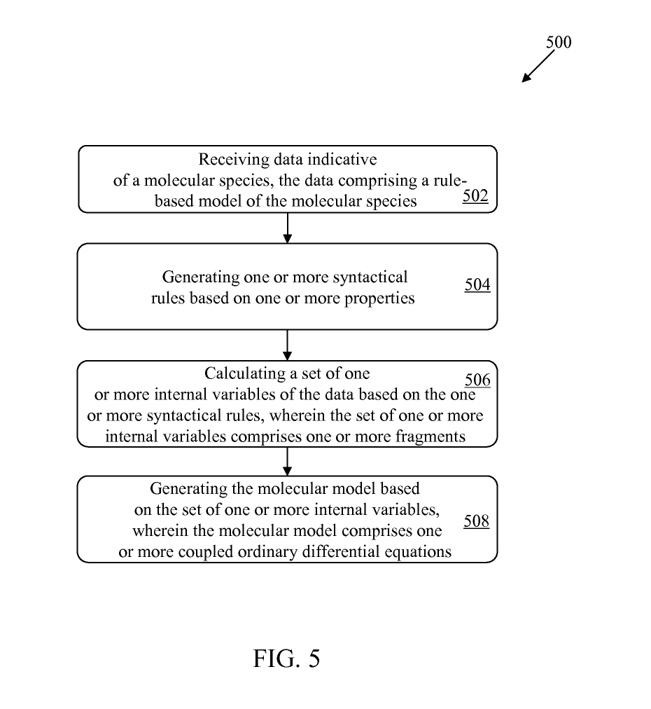

FIG. 5 illustrates an exemplary process 500 for generating a representation of a molecular model according to the present invention (e.g., by the biological modeling system 100). At step 502, the system receives (e.g., by input unit 106 of FIG. 1) data indicative of a molecular system, the data comprising a rule-based model of the molecular interactions. For example, the data indicative of a molecular system can include Kappa defined agents as described above with reference to FIGS. 2A and 2B. At step 504, the system generates one or more syntactical rules based on one or more properties. At step 506, the system calculates (e.g., by preprocessing unit 108) a set of one or more internal variables of the data based on one or more syntactical rules, wherein the set of one or more internal variables comprises one or more fragments. At step 508, the system generates (by model generation unit 112) the representation based on the set of one or more internal variables, wherein the representation comprises one or more coupled ordinary differential equations.

With respect to step 504, syntactical rules (or criteria) can be implemented based on properties of the system (e.g., the properties of steps 304 and 308 of FIG. 3). The biological modeling system 100 can use the syntactical rules to scan all the rules of a rule-based model to determine which agents and sites belong to a fragment. Each fragment includes a plurality of molecular entities whose dynamical roles are indistinguishable at the level of the rule-based model, as described above with reference to FIGS. 3 and 4.

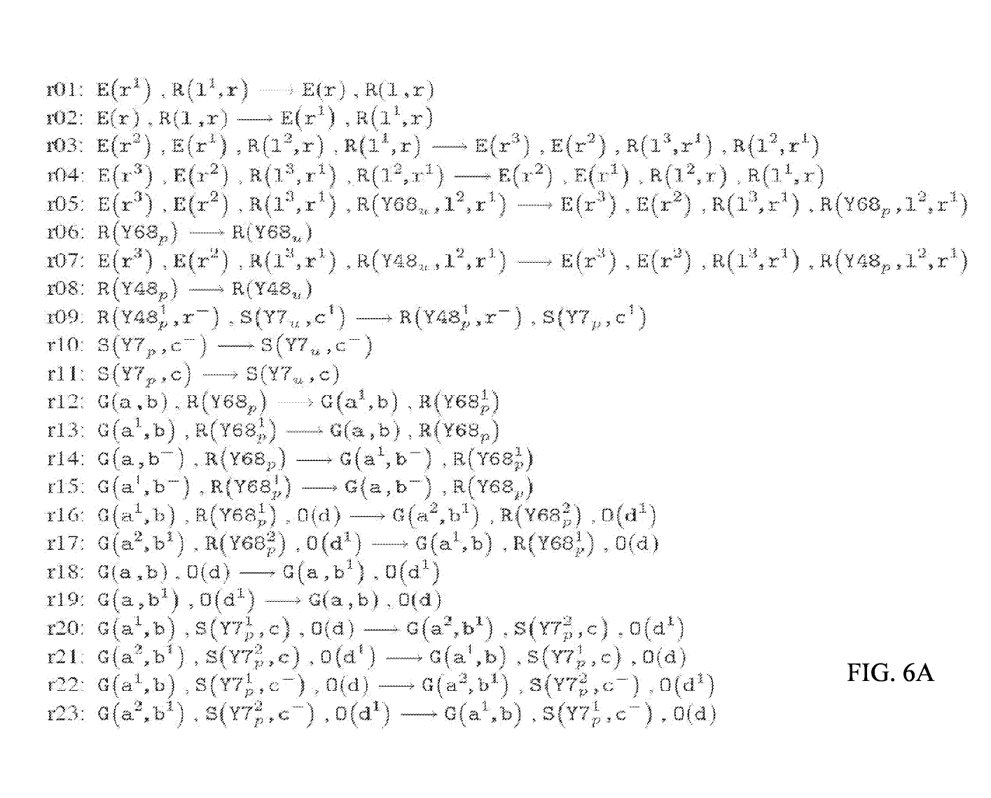

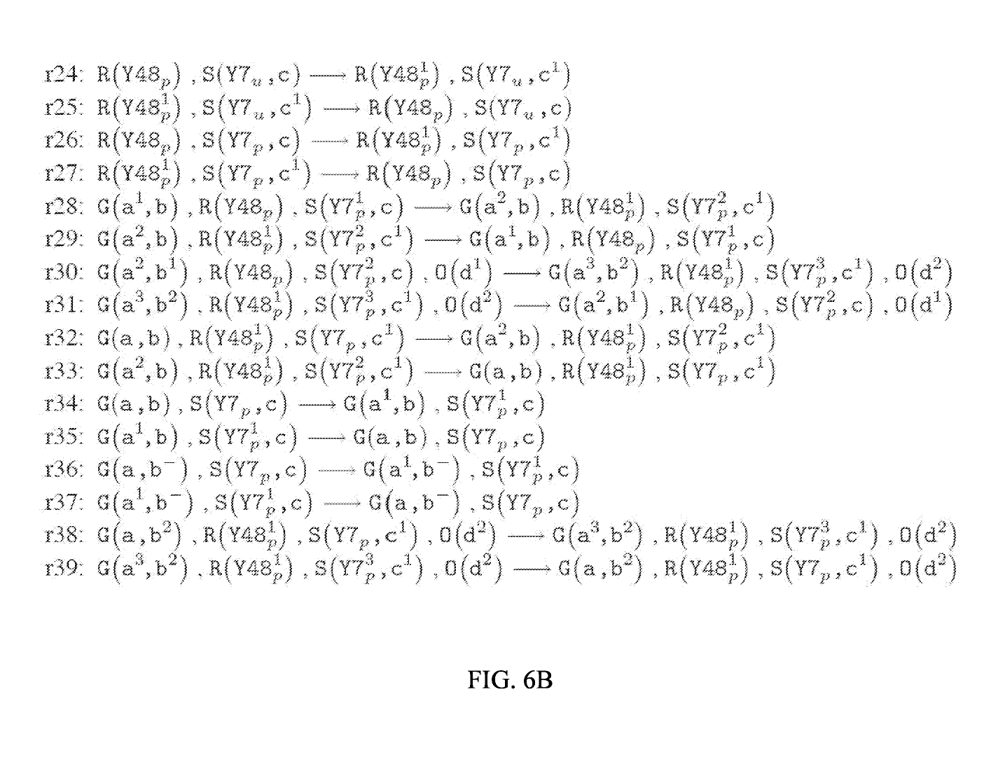

For example, the syntactical rules can be applied to a rule-based model of a small section of early events in epidermal growth factor (EGF) signaling as adapted from Blinov et al., A network model of early events in epidermal growth factor receptor signaling that accounts for combinatorial complexity, BioSystems 83:136-151 (2006), which is hereby incorporated herein by reference in its entirety. These events include the binding of EGF (agent E) to the receptor (R), the subsequent dimerization of the receptor, and the eventual recruitment of SOS (O). The model consists of 39 rules, r01-r39, shown in FIGS. 6A-6B. Separate rules were written for binding and unbinding actions, because unbinding typically occurs under less-restrictive contexts than binding. The names of agent sites were chosen arbitrarily. While those skilled in the art can appreciate that the biological accuracy of the published models from which these rules were adapted might be outdated (because knowledge about EGF signaling mechanisms continues to change rapidly), the description of this example is not for a particular biological insight, but rather to convey a procedure of general interest that can be applied to any rule-based system.

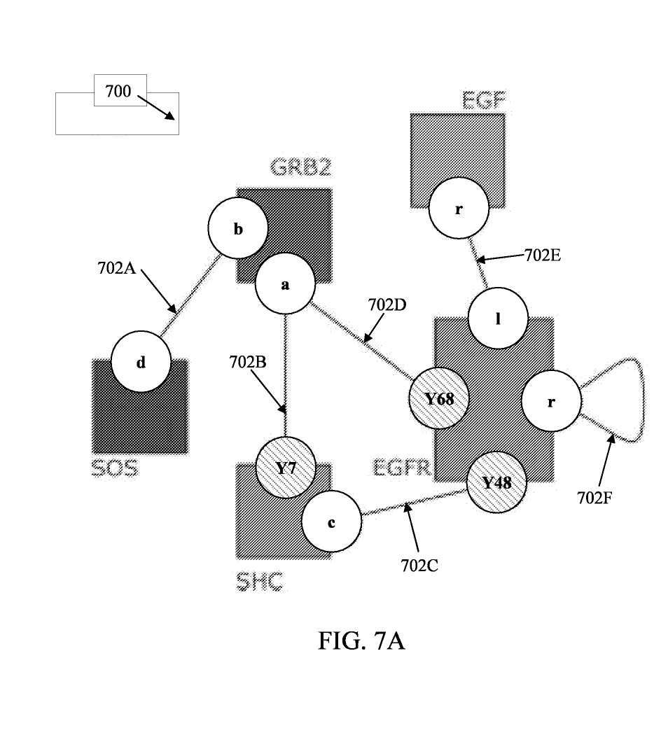

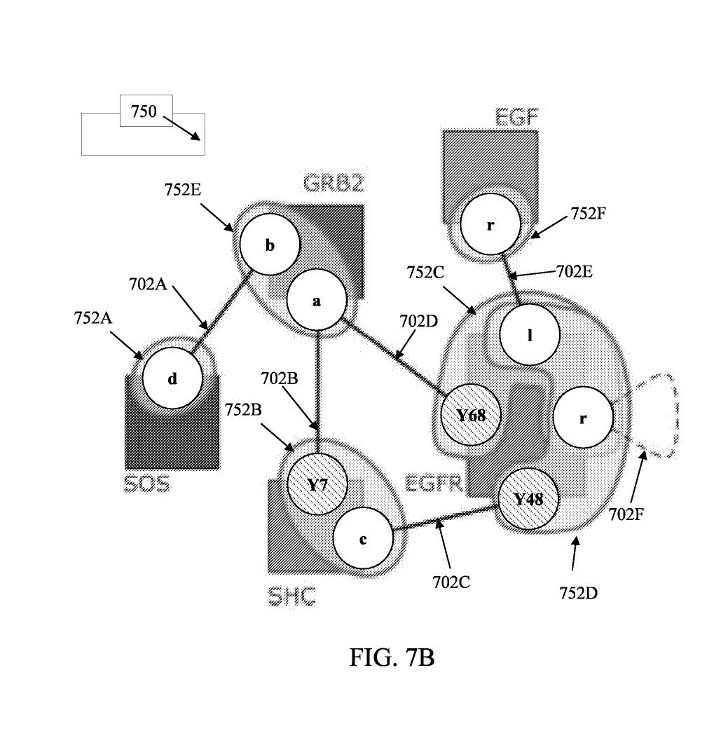

Together, the 39 rules of this example imply 356 possible distinct molecular species. However, based on these rules of interaction, the system can only make 38 internal distinctions, so differential equations in these 38 variables self-consistently describe the dynamics of the system. It can be convenient to use a special map as a canvas for laying out which sites and bindings must appear together in a fragment, which will be referred to as a contact map (CM). FIG. 7A illustrates an exemplary contact map 700 according to the present invention.

The contact map 700 is a graph whose nodes (i.e., “SOS”, “GRB2”, “EGF”, “EGFR”, and “SHC”) are the agents in the model and whose edges (i.e., edges 702A-702F, collectively edges 702) are possible bonds between sites (e.g., edge 702A is a possible bond between sites “b” and “d”). As described above, agents are sets of sites. Filled circles “Y7”, “Y68” and “Y48” indicate sites where their internal state can be modified. In this example, the contact map is a fine-grained version of a protein-protein interaction (PPI) map, in that its edges end in sites of agents and not just agents. A CM can be generated automatically from a rule-based model and provides a summary of attainable interactions.

With further respect to step 506, syntactical rules can be developed to annotate contact maps (e.g., the contact map 700 of FIG. 7A). For example, a parsimonious covering, or covering for short, can be used to annotate contact maps. A covering C of a set S is a set of subsets of S, called classes, such that:
(i) no class is empty,
(ii) no class is a subset of another class, and
(iii) the union of all classes yields S.

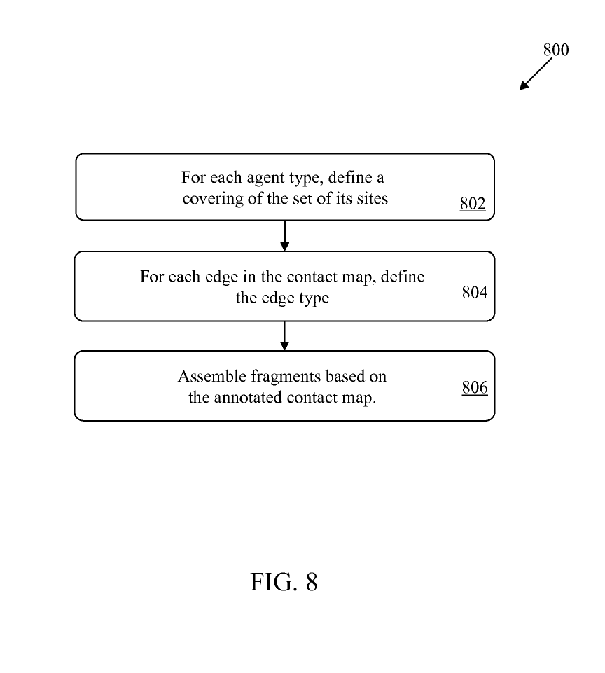

Using the above exemplary definition, a covering differs from a partition in that the elements of a covering need not be pairwise disjoint. In preparation for building fragments, the biological modeling system 100 can first annotate a CM (e.g., by the pre-processing unit 108 of FIG. 1). FIG. 7B illustrates an exemplary annotated contact map 750 according to the present invention. FIG. 7B includes the nodes, edges, and sites as illustrated in FIG. 7A. FIG. 7B, and also includes coverings 752A-752F, which are described in further detail with reference to FIG. 8.

For example, the biological modeling system 100 can annotate the contact map 700 with two (2) types of information obtained by applying syntactical rules. FIG. 8 illustrates an exemplary method for annotating a contact map according to the present invention. At step 802, for each agent type A, the biological modeling system 100 (e.g., by the pre-processing unit 108 of FIG. 1) defines a covering C(A) of the set of its sites. At step 804, for each edge in the CM, the biological modeling system 100 defines its type as either “solid” or “soft.” For example, a solid bond can be defined as a bond that occurs on the lhs of a rule that tests anything other than that bond, where every other bond is a soft bond (e.g., as defined through Edg1 below). At step 806, the biological modeling system 100 assembles fragments based on the annotated CM (ACM) 750.

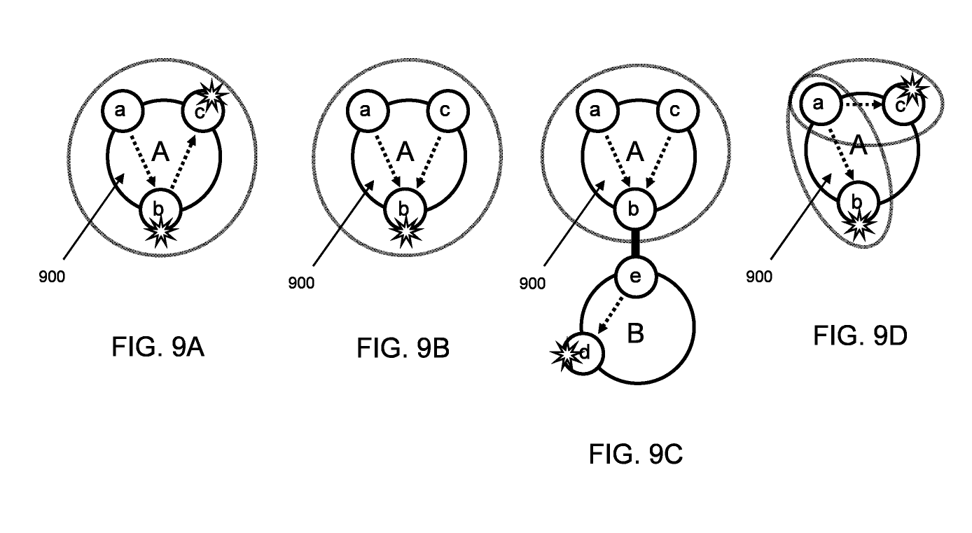

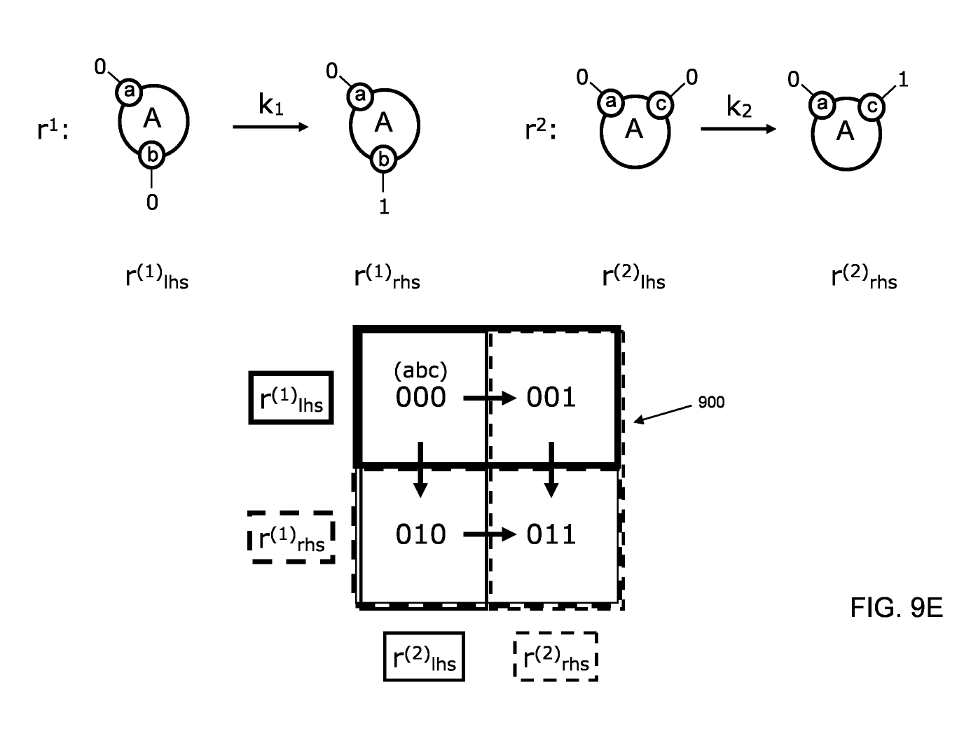

With respect to step 802, syntactical rules (or criteria) can be used to determine valid coverings for an agent and the type of a bond. For example, the three syntactical rules Cov1, Cov2, and Cov3, shown below, can be used (which are described with reference to generic agents “A” and “B” and sites “a” and “b”). FIGS. 9A-9D illustrate exemplary diagrams of the syntactical criteria Cov1 and Cov2, as described below with reference to each rule.

Cover rule 1 (Cov1, e.g., backward closure): If a rule tests a site “a” in an agent “A” and modifies a site “b” in the same agent, any class in C(A) that contains “b” must also contain “a.” For example, FIGS. 9A and 9B illustrate the application of Cov1. When site “a” is tested in both FIGS. 9A and 9B, it modifies site “b”, which is within the same agent as illustrated by the circle 900. In FIG. 9A, site “b” in turn modifies site “c”, whereas in FIG. 9B, site “b” is also modified by site “c.”

Cover rule 2 (Cov2, e.g., relay): If a rule tests a site “a” in an agent A, and A is connected by some path through a site “b” to an agent that is modified, any class in C(A) that contains “b” must also contain “a”. FIG. 9C shows an example of the application of

Cov2. When site “a” is tested on agent A, site “a” is connected to “b”, and “b” is connected to “e” on agent B. Therefore, agent B is modified when site “a” is tested on agent A.

FIG. 9D illustrates two rules r₁ and r₂ that modify sites “b” and “c”, respectively, while both testing a condition on site “a.” For example, let r₁: A(a₀,b₀)→A(a₀,b₁)@k₁ and r₂: A(a₀,c₀)→A(a₀,c₁)@k₂, as shown in FIG. 9E. Chart 950 illustrates the action of the rules on micro-configurations (ground-level objects) 000, 001, 010, and 011. Rule r₁ transforms 000 into 010 and 001 into 011, and rule r₂ transforms 000 into 001 and 010 into 011. The solid rectangles cover the configurations that match the pattern on the lhs of each rule, and the dotted rectangles cover the configurations that match the pattern on the rhs of each rule. The concentration of ground-level configuration 000 is affected by both rules r₁ and r₂, because it matches the lhs of both r₁ and r₂. However, r₂ transforms 000 into 001, which still matches the lhs of rᵢ. In fact, this is an example of a situation in which the glueing region (the glueing region of a pattern B and the lhs of a rule, rₗₕₛ, is the set of agents and sites that both B and rₗₕₛ mention, along with a mutually compatible state) between the lhs of r₁ and the lhs of r₂ does not contain either modified site. Hence, r₂ maps one subset of the extension of 00, into another without affecting the concentration of 00*. Indeed, 00* is a fragment, as we can easily check: d[00*]/dt=d[000]/dt+d[001]/dt=−k₁[000]−k₂[000]−k₁[001]+k₂[000]=k₁[00*]. Agent A has therefore two covering classes, {a, b} and {a, c}, for a total of four fragments: 00*, 01*, 0*0, and 0*1. In general, a covering class contains the backward closure of all sites that control a particular locus of modification.

Cover rule 3 (Cov3, e.g., witness): For each agent in an unmodified lhs component, there must be a class in the agent's covering that contains all of the sites tested by the rule. Syntactical rules can also be implemented to determine the type of a bond. One or more edge rules can be implemented as operational rules to define what constitutes a solid or soft bond. For example, an edge rule (Edg1) can be implemented to indicate that a bond is solid if it occurs on the lhs of a rule that tests anything other than that bond, and all other bonds are soft. Advantageously, such a rule can be used to indicate that pieces (e.g., agents) that are held together by a solid bond are correlated.

The syntactical rules Cov1-Cov3 and Edge1 are exemplary rules that can be used to implement the properties described above (i.e., with reference to FIG. 3 at steps 304 and 308), which are that no fragment properly overlaps a lhs component of a rule on a modified site, and fragments must partition any subfragment. To illustrate this, the biological modeling system 100 can define an overlap between two patterns X and Y as the set of agents and sites both mention along with a mutually compatible state. The overlap, if it exists, can be used as an instruction for gluing the patterns together. The discussion above with reference to FIG. 4 shows that if a pattern has an overlap with a component on the lhs of a rule, and the overlap contains a site modified by the action of the rule, the pattern must be “glued to” the lhs component to become a fragment as far as that rule is concerned. Hence, a fragment A either has no overlap with the sites that are modified by the rule, or it contains a whole lhs component. The biological modeling system 100 repeats the same process (“glue-on-overlap”) for each rule and all agents, starting out with each site in its own class. The biological modeling system uses Cov1 and Cov2 to, for example, keep track of which sites of an agent must be mentioned together in a fragment as a result of the repeated glue-on-overlap process. The biological modeling system 100 uses Cov3 to handle the orthogonality property in the special case of a component required for an action but not modified by it (a “witness”).

The glue-on-overlap process can pull bonds into a fragment (e.g., as discussed with reference to B′ described with reference to FIGS. 3 and 4). However, not all bonds are conduits of control between the parts (e.g., between the parts X and Y) they connect. For example, suppose that the only time a bond appears on the lhs of a rule is in a so-called pure dissociation rule that tests nothing except the existence of the bond that is to be broken. No rule modifying X or Y depends on that bond (or the bond would figure in a rule other than the dissociation rule). As a consequence, the fragments containing X can stop short of including all possible states of Y and vice versa. The fragments containing X only need to specify whether or not X is connected to Y, but they do not need to specify Y itself (and vice versa.). The syntactical rule Edg1 defines those bonds that carry constraints as solid. The biological modeling system 100 can classify all bonds not characterized by Edg1 as solid or soft, and can choose to have smaller or larger covering classes (provided they satisfy any pertinent syntactical rules, such as Cov1-Cov3). Based on either selection, the fragmentation is sound. However, soft bonds make for smaller fragments. The biological modeling system 100 can be configured, for example, to obtain small fragments by choosing covering classes that are as small as possible and considering bonds to be soft when they appear only on the rhs of a rule (bonds that are only formed) and/or on the lhs of a pure dissociation.

With further respect to step 506, to define fragments, it can be convenient to extend the notion of complex with bond stubs. An agent with a bond stub is written A (a^{B@b}), which means that A's site a is bound to B's b, without, however, including agent B in the complex. For example, given an ACM (e.g., the ACM of FIG. 7B), a fragment F is a complex such that: each agent has a set of sites that is a class, every site has an internal state (if any), every site has a binding state (e.g., either free, bound, or stubbed), every stub must correspond to a soft bond in the ACM, and every bond is solid. A subfragment, as discussed above, is a complex that embeds within a fragment. To obtain a fragment, the biological modeling system 100 starts with an agent and a site. The system then determines (via the ACM) which further sites to add and which binding states (e.g., stubbed or not) are appropriate. When there are no more sites to add, one has a fragment.

FIGS. 10A-10B illustrate exemplary fragments F₁-F₃₈, generated by the biological modeling system 100 based on the rules in FIGS. 6A and 6B. As an example of the fragment growth process, consider agent R in the rule set depicted by the contact map of FIG. 7A. According to the ACM in FIG. 7B, the biological modeling system 100 can choose between 2 classes. Suppose, for example, the biological modeling system 100 selects class 752D {l, r, Y48}. Next, the biological modeling system 100 assigns a state to each site in that class. For example, with reference to class 752D, all sites are free, and Y48 is unphosphorylated. This yields fragment R (Y48ᵤ, l, r), which is F₃₄ in FIG. 10B. Alternatively, the biological modeling system 100 can choose Y48 to be phosophorylated, which would generate fragment F₁₅. Yet, if the biological modeling system 100 chooses Y48 to also be bound, then the solid link 702C in the ACM 750 forces agent SHC into the fragment, along with its site c as the link's endpoint. In turn, c forces inclusion of the class to which it belongs, {c, Y7}. Now the biological modeling system 100 needs to assign states to c and Y7 in agent SHC. For example, S (Y7ₚ, c¹), R (Y48ₚ¹, l, r) is one fragment, which is fragment F₀₄ in FIG. 10A.

A further fragment is obtained by considering site r in agent R to be bound. Site r can bind to another R agent, but the link is soft. A soft link at r does not force the inclusion of another instance of R. Instead, the bound state is only indicated with its type: S (Y7ₚ, c¹), R (Y48ₚ¹ , l, r^{R@r}). This fragment, however, does not show up in the list of fragments in FIGS. 10A-10B. Given the set of rules, the state in which R is dimerized at site r cannot occur if the ligand-binding site one is empty. Such a fragment is automatically eliminated from the list because a separate reachable state analysis (as is described below) recognizes it as inaccessible.

Advantageously, fragments as defined above comply with at least the following qualities: (1) no fragment strictly overlaps with a rule component on a modified site, (2) any lhs component is contained in a fragment (i.e., is a subfragment), (3) the concentration of any subfragment can be expressed as a linear combination of fragment concentrations, and (4) fragments are closed under rule actions. Referencing the properties discussed above, quality one embodies the no-overlap property. Qualities two and three embody the second property of orthogonality. The fourth quality means that fragments form a network of reactions (like species). Referencing the syntactical rules, quality one follows from Cov1, Cov2 and Edg1. Quality two follows from Cov3 and Edg1 for non-modified rule components, and Cov1, Cov2 and Edg1 for modified rule components. Qualities three and four follow from the exhaustivity of the growth procedure for fragments. Qualities one through three ensure a sound translation from rules into an ODE system for fragments, as described below for step 508.

With reference to step 508, the system generates (by model generation unit 112) the representation based on the set of one or more internal variables (e.g., the properties and/or the syntactical rules). The representation comprises one or more coupled ordinary differential equations. The system of ODEs derived from the rule-based representation is therefore cast in variables representing sets of molecular entities (i.e., fragments), such that the dynamics of each set as a whole (the equation describing its lumped concentration change in time) is only a function of other sets—thus the system is closed, or self-consistent, in these sets.

The biological modeling system 100 can construct the representation (the dynamical system for fragments) by deriving mass action terms for the consumption and production of fragments from rules. Consider, for example, a rule of the form Z,Z′→Z-Z′, which binds 2 complexes Z and Z′. Based on this rule, the differential equation d[Fᵢ]/dt for each fragment Fᵢ that matches Z obtains a consumption term −y[Fᵢ][Z′], where [Z′] is expressed as a sum of concentrations of orthogonal fragments using qualities two and three above. The factor y depends on the rate constant of the rule and the number of ways that Z embeds into Fᵢ. On the production side, the kinetic terms depend on the bond type in the ACM. Consider, for example, a solid bond. A kinetic term y[Fᵢ][Fⱼ] is generated for the differential equation d[Fₖ]/dt of every fragment Fₖ that matches Z-Z′, where Fᵢ and Fⱼ are fragments matching Z and Z′, respectively, subject to the constraint that the match of Fₖ is the disjoint sum of the embeddings of Z and Z′ into their respective fragments. If the bond in Z-Z′ is soft and corresponds to a . . . A.a-b.B . . . , the biological modeling system 100 can replace Z-Z′ with Z^{B@b}, Z′^{A@a}, because there is no information in Z′^{A@a} affecting Z^{B@b}. Every fragment Fₖ matching Z^{B@b} gains a production term y[Fᵢ][Z′], where Fᵢ matches Z and is related to the Fₖ matching Z^{B@b}. A similar argument applies to, for example, fragments that match Z′^{A@a}.

The dissociation of a solid bond Z-Z′ can give rise to a piece Z (and also Z′) that embeds into a fragment F. To determine the contribution of the dissociation rule to the rate of production of F, the biological modeling system 100 needs the concentration of F-Z′. However, F-Z′ is not itself a fragment but, rather, a subfragment. This is why, for the methods disclosed herein to result in a closed system of equations, the biological modeling system 100 must be able to express the concentration of a subfragment in terms of fragments (see, e.g., quality three and property two above).

In some examples, an overapproximation a of the set of reachable species can be used to underlie the systems and/or methods disclosed herein, deploying a framework of abstract interpretation. This overapproximation can come into play, for example, at junctures such as: (i) the contact map reports edges and site modifications only if they are reachable by α, (ii) fragments that are not reachable by α are discarded, and (iii) the procedure for compressing rules (as will be explained below) makes use of α. In some examples, α is exact (e.g., the above-described EGF example).

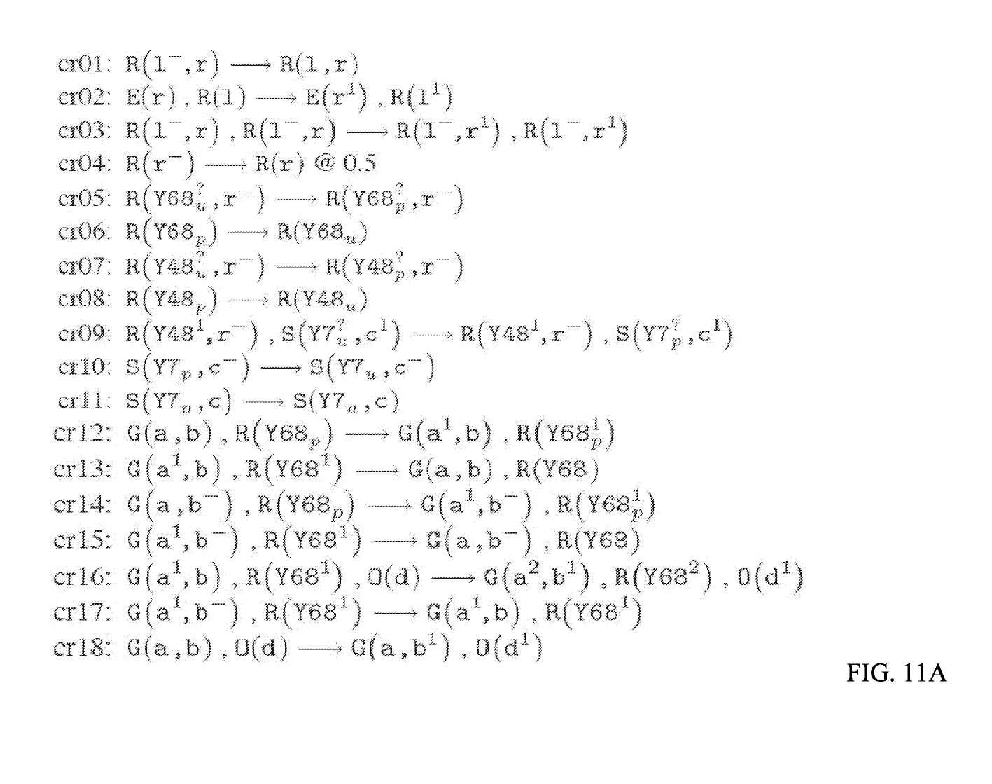

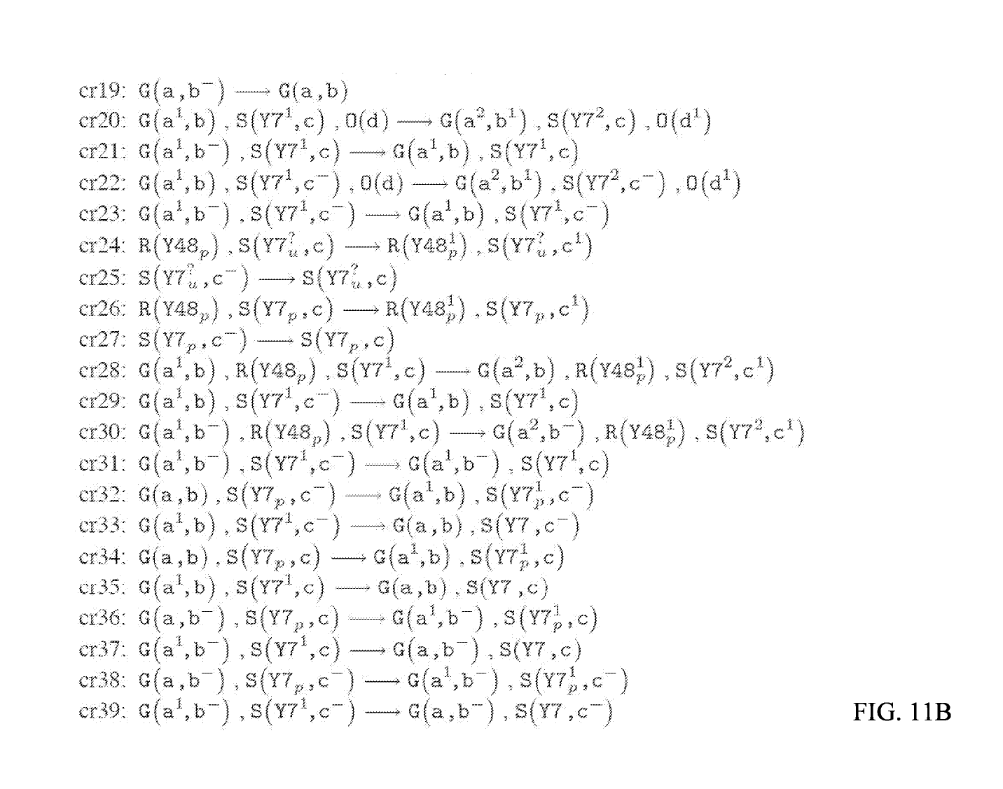

With further reference to step 506, because fragment construction proceeds by inspecting the structure of rules, in some embodiments it can be important that rules be concise (in the sense of avoiding redundant contextual conditions (or tests) on each rule's lhs). However, what classifies as redundant often depends on the remaining rules in the model. Because rules record empirical observations or hypotheses, they tend to be crafted in isolation. Consider, for example, rule r02 expressing the binding of ligand to receptor: R (l, r), E (r)3R (l¹, r), E (r¹). The rule mentions two sites, l and r, of the receptor R. Site one is the ligand (EGF)-binding site, whose state is modified by the action of r02, whereas r is the site at which the receptor dimerizes (as described in r03). Rule r02 asserts that binding of E (EGF) to R requires not just a free 1, but also a free r. Given the other rules of the model, there is no reachable state of the reaction mixture in which R could dimerize before binding E. Hence, in the context of the remaining 38 rules of this model, asking for site r to be free is a redundant condition for the firing of rule r02, because a free 1 implies a free r. Without removing such redundancies, fragments would be more numerous and bloated by fictitious dependencies. To reduce the extent to which this happens, the biological modeling system 100 can preprocess (e.g., via the preprocessing unit 108) a rule system with an automatic compression that removes unnecessary contextual specifications. This technique rests on the reachability overapproximation, α, referred to in the previous paragraph. FIGS. 11A-11B illustrate an exemplary list of compressed rules cr01-cr39 from which the thirty-eight (38) fragments of FIGS. 10A-10B were derived according to the present invention.

With further reference to step 506, in some embodiments, ground-level reactions into which a rule expands inherit the rule's rate constant (after accounting for possible symmetry reductions upon expansion). Beyond any specific values of rate constants, rules themselves already imply a notion of kinetic distinguishability. For example, with the EGF example above posits that the phosphorylated EGFR receptor (R) binds the protein SHC (S), which would read as R (Y48ₚ), S (c)→R (Y48ₚ¹), S (c¹). Yet, such a rule does not appear in the model. Rather, the same binding action between R and S is found in the two rules r24 and r28 that differ in their contexts. Rule r24, R (Y48ₚ), S (c, Y7ᵤ) 3 R (Y48ₚ¹), S (c¹, Y7ᵤ), specifies that site Y7 of S must be unphosphorylated and free, whereas rule r28, R (Y48ₚ), S (c, Y7ₚ¹),G (a¹, b) 3 R (Y48ₚ²), S (c^{2, Y7}ₚ¹), G (a¹, b), specifies that Y7 of S is phosphorylated and bound to G. The only reason to warrant such a distinction is an actual or hypothesized difference in the rate constants for the two contexts. Therefore, regardless of the specific values of the rate constants, positing two rules with different contexts for the same action affects the construction of fragments. The precise values of the rate constants of rules enter the ODEs for fragments, but they do not affect the fragments themselves, because the latter are based on the distinguishability of control flows shaped by rule contexts.

In some embodiments, the biological modeling system 100 can calibrate parameters of a rule-based model (e.g., of a molecular interaction system) by fitting parameters (with traditional means) of a reduced system of differential equations corresponding to the rule-based model.

In some embodiments, the biological modeling system 100 can define a complexity metric of a rule-based model based on the fragments and relationships between the fragments. Calculating the complexity metric comprises counting and characterizing the size of the fragments that make up the representation generated from the rule-based model. For example, a system that has three hundred fragments processes more information than a system with ten fragments, since a fragment is an “information bearing unit.” A fragment is an information bearing unit because the system (e.g., the biological modeling system 100) can guarantee that the system dynamics can distinguish fragments from one another. For example, a fragment aggregates molecular species that cannot be distinguished from one another by the system. What cannot be distinguished cannot bear information, so a fragment can be viewed as an equivalence class of molecular species. The system can characterize the size of fragments by, for example, reporting the size distribution (e.g., does a system contain many small fragments and a few large fragments, mostly large fragments, etc.).

The biological modeling system 100 can define a second complexity metric of a second rule-based model based the fragments of the second rule-based model and the relationships between the fragments. The biological modeling system 100 can determine whether the rule-based model is equivalent to the second rule-based model based on the first complexity metric and the second complexity metric.

In some embodiments, the systems and methods can be used to determine different potential drug targets with the same effect with respect to the rule-based dynamics of a particular biological system. Interventions through molecular entities that are lumped together into a particular set (e.g., a fragment) by means of the methods disclosed herein are equivalent with respect to the dynamical consequences on the modeled system. However, in some examples, the molecular entities may not be equivalent with respect to side effects on other aspects of a biological system that are not being modeled. Given, for example, additional knowledge about the pharmaceutical interactions of a compound, the methods disclosed herein can be utilized to list alternative drug targets that have the same dynamical consequences (and therefore are suitable) with respect to the modeled dynamics, but may lack undesirable consequences.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit). Subroutines can refer to portions of the computer program and/or the processor/special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage devices suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

The components of the computing system can be interconnected by any form or medium of digital or analog data communication (e.g., a communication network). Examples of communication networks include circuit-based and packet-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Devices of the computing system and/or computing devices can include, for example, a computer, a computer with a browser device, a telephone, an IP phone, a mobile device (e.g., cellular phone, personal digital assistant (PDA) device, laptop computer, electronic mail device), a server, a rack with one or more processing cards, special purpose circuitry, and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). A mobile computing device includes, for example, a Blackberry®. IP phones include, for example, a Cisco® Unified IP Phone 7985G available from Cisco System, Inc, and/or a Cisco® Unified Wireless Phone 7920 available from Cisco System, Inc.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computerized method for automatically generating a representation of a molecular system comprising:
receiving, by an input unit of a computer, data indicative of a molecular system, the data comprising a rule-based model of the molecular interactions;
calculating, by a preprocessing unit of the computer, a set of one or more internal variables of the data based on one or more syntactical rules, wherein the set of one or more internal variables comprises one or more fragments; and
generating, by a model generation unit of the computer, the representation based on the set of one or more internal variables, wherein the representation comprises one or more coupled ordinary differential equations.

2. The method of claim 1, wherein the one or more fragments comprise a plurality of molecular entities whose dynamical roles are indistinguishable at the level of the rule-based model.

3. The method of claim 2, wherein the representation of molecular entities comprises one or more agents and one or more sites.

4. The method of claim 1, further comprising generating the one or more syntactical rules based on one or more properties, the one or more properties comprising:
verifying no fragment property overlaps a left-hand component of a rule on a modified site; or
verifying the one or more fragments partitions each component of the rule-based model so that each component can be expressed as a sum of orthogonal fragments; or both.

5. The method of claim 4, wherein generating comprises generating the representation such that:
the representation is self-consistent, wherein the dynamics of each fragment of the one or more fragments is a function of the remaining fragments of the one or more fragments; and
a first state of the representation is equal to a second state of the representation, wherein the first state is calculated by numerically integrating the one or more fragments, and the second state is calculated by numerically integrating the rule-based system and then generating the one or more fragments.

6. The method of claim 1, further comprising calibrating a set of one or more parameters of the rule-based model, comprising fitting a set of one or more parameters of the generated representation of the rule-based model.

7. The method of claim 1, further comprising defining a complexity metric of the rule-based model based on the one or more fragments and one or more relationships between the one or more fragments.

8. The method of claim 7, further comprising:
defining a second complexity metric of a second rule-based model based on one or more fragments of the second rule-based model and one or more relationships between the one or more fragments of the second rule-based model; and
determining whether the rule-based model is equivalent to the second rule-based model based on the first complexity metric and the second complexity metric.

9. The method of claim 7, wherein the complexity metric comprises counting and characterizing the size of one or more fragments that make up the representation generated from the rule-based model

10. The method of claim 1, further comprising calculating a plurality of different potential drug targets, wherein each drug target is a molecular entity within a same fragment from the one or more fragments, each drug target of the plurality of different potential drug targets having the same dynamical consequences as the other drug targets.

11. The method of claim 1, wherein calculating the set of one or more internal variables comprises:
generating a contact map, the contact map representative of a plurality of agents and a plurality of bonds between the agents; and
generating an annotated contact map based on the contact map, the annotated contact map being generated based on one or more criteria that determine valid coverings for each agent of the plurality of agents and a type of bond of each agent.

12. The method of claim 11, further comprising assembling the one or more fragments such that:
each agent within the fragment has a set of one or more sites that is a class; and
each site of the one or more sites has a binding site selected from the group consisting of free, bound, or stubbed.

13. A system for automatically generating a representation of a molecular system, the system comprising:
an input unit of a computer configured to receive data indicative of a molecular system, the data comprising a rule-based model of the molecular interactions;
a preprocessing unit of the computer in communication with the input unit, configured to calculate a set of one or more internal variables of the data based on one or more syntactical rules, wherein the set of one or more internal variables comprises one or more fragments; and
a model generation unit of the computer in communication with the preprocessing unit, configured to generate the representation based on the set of one or more internal variables, wherein the representation comprises one or more coupled ordinary differential equations.

14. A computer program product, tangibly embodied in a computer readable storage medium, the computer program product including instructions being operable to cause a data processing apparatus to:
receive data indicative of a molecular system, the data comprising a rule-based model of the molecular interactions;
calculate a set of one or more internal variables of the data based on one or more syntactical rules, wherein the set of one or more internal variables comprises one or more fragments; and
generate the representation based on the set of one or more internal variables, wherein the representation comprises one or more coupled ordinary differential equations.

15. A system for automatically generating a representation of a molecular system, the system comprising:
means for receiving, by an input unit of a computer, data indicative of a molecular system, the data comprising a rule-based model of the molecular interactions;
means for calculating, by a preprocessing unit of the computer, a set of one or more internal variables of the data based on one or more syntactical rules, wherein the set of one or more internal variables comprises one or more fragments; and
means for generating, by a model generation unit of the computer, the representation based on the set of one or more internal variables, wherein the representation comprises one or more coupled ordinary differential equations.
